(19) United States
(12) Patent Application Publication
(10) Pub. No.: US 2009/0150424 A1
(43) Pub. Date: Jun. 11, 2009

(54) SYSTEM AND SOFTWARE FOR AUTOMATING AN INFORMATION DISCLOSURE STATEMENT

(76) Inventor: Howard H. Sheerin, Scottsdale, AZ (US)

Correspondence Address: Howard H. Sheerin, Attorney at Law, 23233 N. Pima Rd., Suite 113, PMB 174, Scottsdale, AZ, 85255, US

(21) Appl. No.: 11/953,071

(22) Filed: Dec. 9, 2007

(51) Int. Cl. G06F 7/00; G06F 15/16

(52) U.S. Cl. 707/102; 709/202; 707/E17.008

(57) ABSTRACT

A method is disclosed for automating an information disclosure statement (IDS). A reference id is sent over a network to a patent database site, and reference data is received over the network from the patent database site corresponding to the reference id. The reference data is imported into an IDS file using Adobe Acrobat. In one embodiment the method is performed by an applicant computer communicating with a patent database site (e.g., a web site), and in an alternative embodiment, an applicant computer communicates with an intermediate site (e.g., a web site) which communicates with the patent database site. Another embodiment of the present invention comprises a computer readable storage medium storing code segments for implementing the method.

### BACKGROUND

The United States require applicants for patents to submit prior art material to patentability in an information disclosure statement (IDS). The IDS is typically generated as a form fillable Adobe Acrobat file (a .pdf file) a template of which can be downloaded from the United States Patent and Trademark Office web site (uspto.gov) and is shown in FIG. 1. It can take a significant amount of time to fill out the IDS form manually by opening each reference file and entering the relevant information.

There is, therefore, a need to automate the process of creating an IDS for a patent application.

### BRIEF DESCRIPTION OF THE DRAWINGS

FIG. 1 shows an IDS template downloaded from the United States Patent and Trademark Office web site (uspto.gov).

FIG. 2A shows a system for implementing an embodiment of the present invention comprising an applicant computer receiving reference data from a patent database web site over the Internet.

FIG. 2B shows a system for implementing an embodiment of the present invention wherein the applicant computer transmits a reference id (or multiple ids) to an intermediate web site which receives the corresponding reference data from the patent database web site and then transmits IDS data to the applicant computer.

FIG. 3A is a flow diagram according to an embodiment of the present invention wherein a template XML file is created by exporting data from an IDS file using Adobe Acrobat.

FIG. 3B is a flow diagram according to an embodiment of the present invention wherein the reference data received from the patent database site is used to modify the template XML file which is then imported into an IDS file using Adobe Acrobat.

FIG. 4A shows example reference data received from the patent database site for a particular patent number.

FIG. 4B shows example XML data that corresponds to the reference data of FIG. 4A, wherein the XML data is used to modify an XML file.

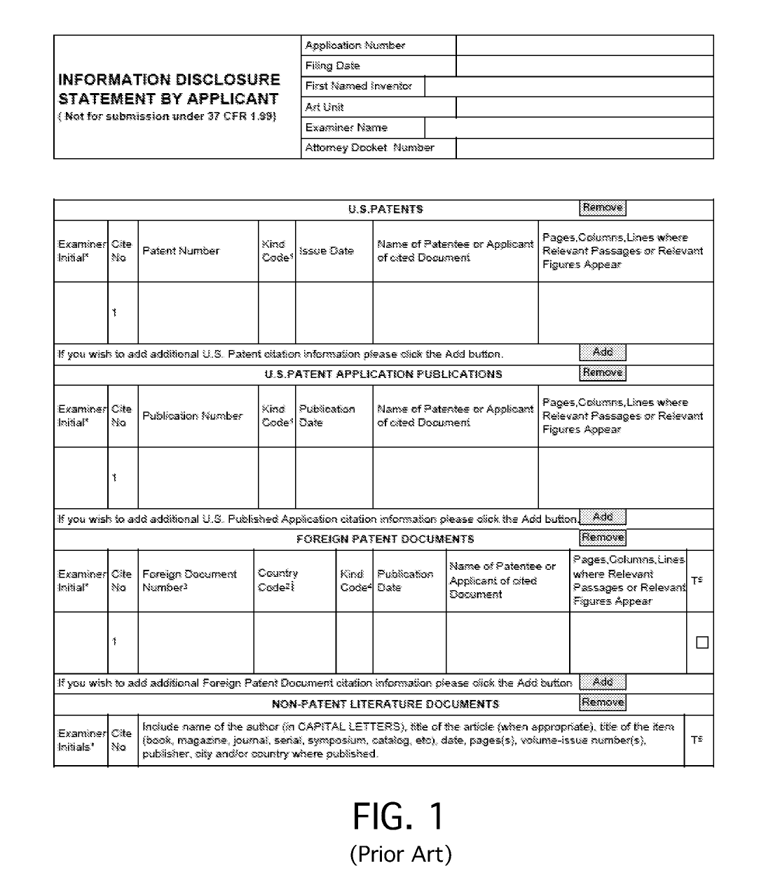

### DETAILED DESCRIPTION OF EMBODIMENTS OF THE INVENTION

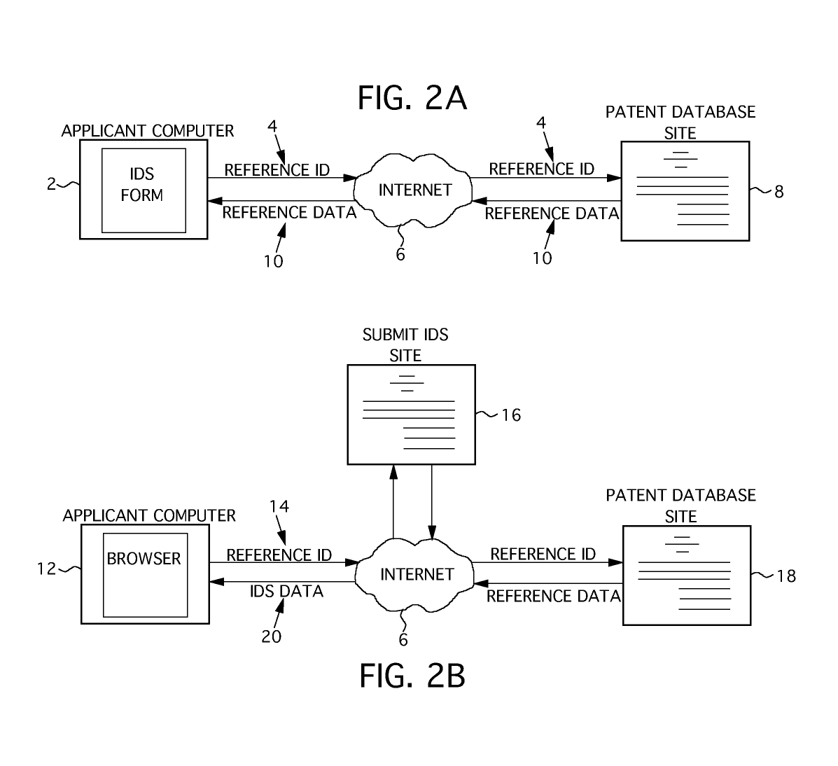

FIG. 2A shows a system according to an embodiment of the present invention for automating an information disclosure statement (IDS). An applicant computer 2 transmits a reference id (or multiple ids) 4 over a network 6 (e.g., the Internet) to a patent database site 8 (e.g., a web site). The applicant computer 2 then receives reference data 10 over the network 6 from the patent database site 8 corresponding to the reference id 4. The applicant computer 2 then imports the reference data into an IDS file using Adobe Acrobat.

In one embodiment, the applicant computer 2 executes an application for communicating over the network, for example, a browser type program for accessing web sites over the Internet 6. The step of importing the reference data 10 into the IDS file using Adobe Acrobat may be implemented using code segments integrated with the browser type program, or it may be implemented using separate code segments such as a script for manipulating Adobe Acrobat. In another embodiment, the step of importing the reference data 10 into the IDS file using Adobe Acrobat is performed manually.

FIG. 2B shows a system according to an alternative embodiment of the present invention wherein an applicant computer 12 transmits a reference id (or multiple ids) 14 to an intermediate site 16 (e.g., a web site submitIDS.com). The intermediate site 16 then transmits the same (or similar) reference id to a patent database site 18 which returns reference data to the intermediate site 16. The intermediate site 16 then converts the reference data into suitable import data (e.g., XML data) for importing into an IDS file using Adobe Acrobat. In one embodiment, the intermediate site 16 performs the step of importing the import data into the IDS file using Adobe Acrobat, and then transmits the IDS file 20 to the applicant computer 12. In an alternative embodiment, the intermediate site 16 transmits the import data 20 to the applicant computer 12 which then imports the import data into the IDS file using Adobe Acrobat. In the embodiment of FIG. 2B, the applicant computer 12 executes a suitable browser program (e.g., Internet Explorer) for communicating with the intermediate site 16 over a network (e.g., the Internet).

The reference id may be generated at the applicant computer in any suitable manner. In one embodiment, the applicant computer generates a list of reference ids, for example, using a word processing program. In an alternative embodiment, the applicant computer stores a plurality of reference data files (e.g., patent documents) in a directory and executes a suitable program for converting the file names in the directory into a text list of reference ids. In yet another embodiment, a combination of the above techniques may be employed to generate the list of reference ids. In one embodiment, the reference ids are transmitted individually to either the patent data base site (FIG. 2A) or to the intermediate site (FIG. 2B). In an alternative embodiment, the applicant computer transmits the list of reference ids to the patent database site or to the intermediate site (e.g., using a copy and paste command).

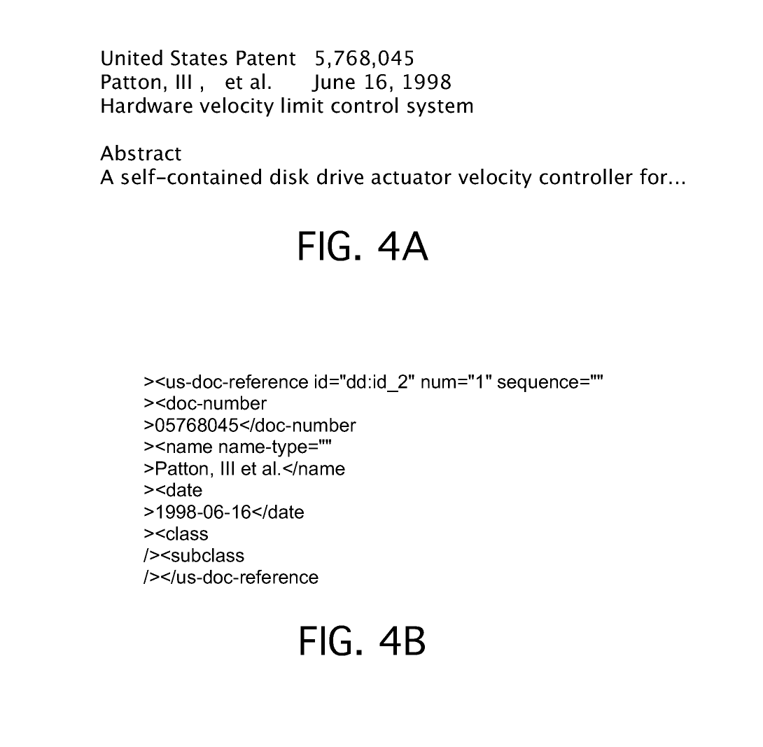

Any suitable patent database site may be employed in the embodiments of the present invention. In one embodiment, the patent database site comprises the United States Patent and Trademark Office web site (uspto.gov), wherein a reference id is transmitted to the site by transmitting an appropriate Hypertext Transfer Protocol (HTTP) command. For example, an HTTP command to retrieve reference data corresponding to U.S. Pat. No. 5,768,045 comprises:
http://patft.uspto.gov/netacgi/nph-Parser?Sect1=PTO1&Sect2=HITOFF&d=PALL&p=1&u=%2Fnetahtml%2FPT O%2Fsrchnum.htm&r=1&f=G&I=50&s1=5768045.PN.&OS=PN/5768045&RS=PN/5768045
   A portion of the relevant reference data returned by the USPTO web site is shown in FIG. 4A, including the patent number, first named inventor, issue date, title, and abstract.

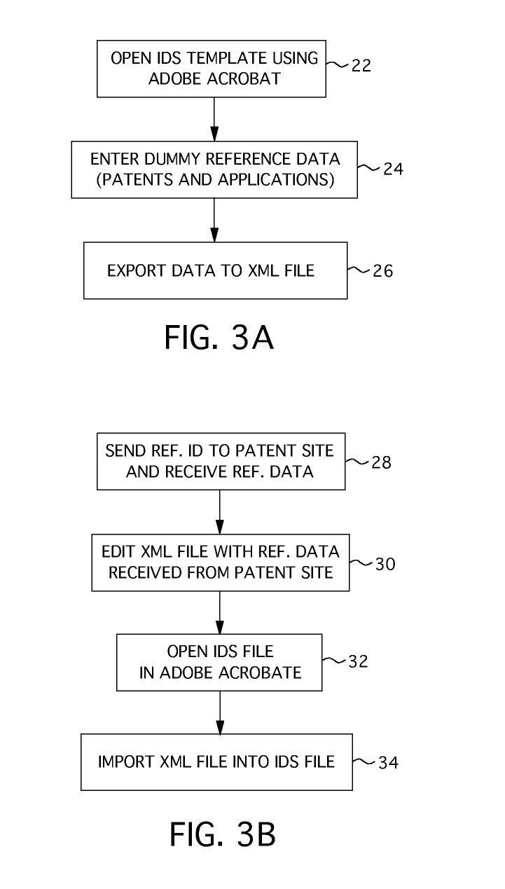

Any suitable technique may be employed to generate the IDS file using Adobe Acrobat. In an embodiment shown in the flow diagram of FIG. 3A, an IDS template file (e.g., the .pdf file downloaded from the uspto.gov web site) is opened (step 22) and dummy reference data entered into the fields (step 24). In one embodiment, dummy data for patent numbers and application numbers are entered into the fields. The “Export Data” command under the “Document->Forms” menu command is selected in order to export the IDS file to an XML file (step 26). In an alternative embodiment, the XML file may simply be generated, for example, using a word processor or any other suitable technique.

Referring now to the flow diagram of FIG. 3B, a reference id (or multiple ids) are transmitted over the network to the patent database site and the corresponding reference data is received (step 28). The XML file generated by FIG. 3A is then edited using the reference data received from the patent database site in order to incorporate the reference data into the XML file (step 30). In an alternative embodiment, the XML file is created during this step and the reference data incorporated directly. Once the XML file has been created, an IDS file (e.g., the IDS template file) is opened in Adobe Acrobat (step 32). The IDS file may be opened in Adobe Acrobat using any suitable technique, such as selecting the IDS file from the desktop, or opening the file using the “Open” menu command from within Adobe Acrobat. Once the IDS file is open in Adobe Acrobat, the XML file is imported into the IDS file using the “Import Data” command under the “Document->Forms” menu (step 34). This step may be executed in any suitable manner, such as by manually selecting the “Import Data” command or by executing a suitable script file to select the command.

FIG. 4B shows example XML data generated in response to the reference data shown in FIG. 4A received from the patent database site. The XML data may be generated using any suitable technique, such as by generating the entire XML data or by editing existing template XML data. The XML data may be generated manually using a suitable word processor, or it may be generated automatically using a suitable program, such as a suitable application or script file. In addition, any suitable data may be generated for importing into an IDS file using Adobe Acrobat, not just XML data.

Any suitable version of Adobe Acrobat may be employed in the embodiments of the present invention, such as version 8.1.1. A copy of Adobe Acrobat may be downloaded from the Internet for execution on the applicant computer and/or the intermediate site 16. One embodiment of the present invention comprises a computer readable medium (e.g., a disk medium or a semiconductor medium) storing code segments for executing the flow diagrams described herein, wherein the code segments may be executed by the applicant computer and/or the intermediate site 16. The code segments may be implemented in any suitable manner, such as C code assembled into an executable file, or a suitable script file, or a combination thereof. In addition, existing programs (e.g., a browser program) may be used to implement (or augment) the embodiments of the present invention.

What is claimed is:

1. A method of automating an information disclosure statement (IDS), the method comprising:
sending a reference id over a network to a patent database site;
receiving reference data over the network from the patent database site corresponding to the reference id; and
importing the reference data into an IDS file using Adobe Acrobat.

2. The method as recited in claim 1, wherein importing the reference data into the IDS file comprises:
opening the IDS file in Adobe Acrobat;
selecting an Import Data command; and
selecting a file comprising the reference data.

3. The method as recited in claim 1, further comprising converting the reference data into Extensible Markup Language (XML) data.

4. The method as recited in claim 3, further comprising storing the XML data in an XML file.

5. The method as recited in claim 3, further comprising editing an XML file using the XML data.

6. The method as recited in claim 4, further comprising importing the XML file into the IDS file.

7. The method as recited in claim 1, wherein the network comprises the Internet.

8. A computer readable storage medium storing code segments for automating an information disclosure statement (IDS), the code segments for:
sending a reference id over a network to a patent database site;
receiving reference data over the network from the patent database site corresponding to the reference id; and
importing the reference data into an IDS file using Adobe Acrobat.

9. The computer readable storage medium as recited in claim 8, wherein importing the reference data into the IDS file comprises:
opening the IDS file in Adobe Acrobat;
selecting an Import Data command; and
selecting a file comprising the reference data.

10. The computer readable storage medium as recited in claim 8, further comprising code segments for converting the reference data into Extensible Markup Language (XML) data.

11. The computer readable storage medium as recited in claim 10, further comprising code segments for storing the XML data in an XML file.

12. The computer readable storage medium as recited in claim 10, further comprising code segments for editing an XML file using the XML data.

13. The computer readable storage medium as recited in claim 11, further comprising code segments for importing the XML file into the IDS file.

14. The computer readable storage medium as recited in claim 8, wherein the network comprises the Internet.

15. A computer readable storage medium storing code segments for automating an information disclosure statement (IDS), the code segments for:
receiving reference data over a network from a patent database site corresponding to a reference id; and
converting the reference data into Extensible Markup Language (XML) data.

16. The computer readable storage medium as recited in claim 15, further comprising code segments for importing the XML data into an IDS file using Adobe Acrobat.

17. The computer readable storage medium as recited in claim 15, further comprising code segments for storing the XML data in an XML file.

18. The computer readable storage medium as recited in claim 17, further comprising code segments for importing the XML data into an IDS file by:
opening the IDS file in Adobe Acrobat;
selecting an Import Data command; and
selecting the XML file to import.

19. The computer readable storage medium as recited in claim 15, further comprising code segments for transmitting the XML data to an applicant computer.

20. The computer readable storage medium as recited in claim 15, further comprising code segments for transmitting the IDS file to an applicant computer.
